(19) United States
(12) Patent Application Publication
(10) Pub. No.: US 2016/0180155 A1
(43) Pub. Date: Jun. 23, 2016

(54) ELECTRONIC DEVICE AND METHOD FOR PROCESSING VOICE IN VIDEO

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU ZHANG, Shenzhen (CN); JUN-JIN WEI, New Taipei (TW)

(21) Appl. No.: 14/726,733

(22) Filed: Jun. 1, 2015

(30) Foreign Application Priority Data
Dec. 22, 2014 (CN) 201410808550.6

(51) Int. Cl. G06K 9/00; G10L 25/57; G10L 13/02

(52) U.S. Cl. CPC G06K 9/00335; G06K 9/00765; G10L 13/02; G10L 25/57

(57) ABSTRACT

A method for processing voice data of a user in a video by using an electronic device. A relationship between a lip feature of a user and word information is established, when a decibel value of the voice data of the user is less than a first predetermined value in condition that voice data of the video is the same as voice data of the user, one or more video segments in which the decibel value of the user is less than the first predetermined value is extracted. As responding to the relationship, word information of voice data of the user in the extracted video segment is accessed, and the electronic device transforms the word information to audible spoken words.

### CROSS-REFERENCE TO RELATED APPLICATIONS

This application claims priority to Chinese Patent Application No. 201410808550.6 filed on Dec. 22, 2014, the contents of which are incorporated by reference herein.

### FIELD

The subject matter herein generally relates to the field of data processing, and particularly to process voice data in a video.

### BACKGROUND

When a user is recording a video in a noisy environment, it is difficult to understand what the user said in the video. Furthermore, difficulties in such situation are apparent for users with hearing handicap.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 is a block diagram of an example embodiment of function modules of a voice data processing system in an electronic device.

FIG. 3 is a flowchart of an example embodiment of a voice data processing method using an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. The term “comprising,” when utilized, means “including, but not necessarily limited to”, it specifically indicates open-ended inclusion or membership in the so-described combination, group, series and the like. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

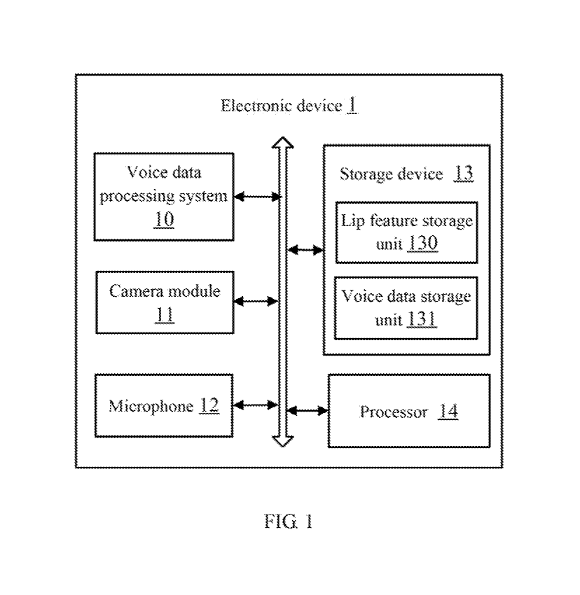

FIG. 1 is a block diagram of an example embodiment of an electronic device. In at least one embodiment, an electronic device 1 includes a voice data processing system 10. The electronic device 1 can be a smart phone, a personal digital assistant (PDA), a tablet computer, or other electronic device. The electronic device 1 further includes, but is not limited to, a camera module 11, a microphone 12, a storage device 13, and at least one processor 14. The camera module 11 can record video, and the microphone 12 can record the audible aspect of the video. FIG. 1 illustrates only one example of the electronic device, other examples can include more or fewer components than as illustrated, or have a different configuration of the various components in other embodiments

In at least one embodiment, the storage device 13 can include various types of non-transitory computer-readable storage mediums. For example, the storage device 13 can be an internal storage system, such as a flash memory, a random access memory (RAM) for temporary storage of information, and/or a read-only memory (ROM) for permanent storage of information. The storage device 13 can also be an external storage system, such as a hard disk, a storage card, or a data storage medium.

In at least one embodiment, the storage device 13 includes a lip feature storage unit 130, and a voice data storage unit 131. The lip feature storage unit 130 stores a standard mapping table including relations between standard movements of lips of peoples when speaking (lip feature) and words actually spoken (word information). In at least one embodiment, the lip feature is extracted by using a lip motion feature extraction algorithm based on motion vectors of feature points between frames of a video. The voice data storage unit 131 stores the sounds of voices of a user of the electronic device 1. In at least one embodiment, the voice data includes a timbre feature value of the user.

The at least one processor 14 can be a central processing unit (CPU), a microprocessor, or other data processor chip that performs functions of the electronic device 1.

The voice data processing system 10 can process voice data in a video when a decibel value of the voice data of the user is less than a first predetermined value in condition that voice data of the video is the same as voice data of the user.

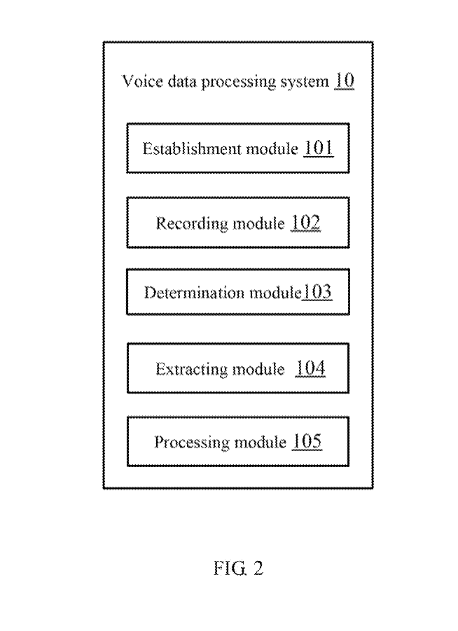

FIG. 2 is a block diagram of one embodiment of function modules of the voice data processing system. In at least one embodiment, the voice data processing system 10 can include an establishment module 101, a recording module 102, a determination module 103, an extracting module 104, and a processing module 105. The function modules 101, 102, 103, 104, and 105 can include computerized codes in the form of one or more programs which are stored in the storage device 13. The at least one processor 14 executes the computerized codes to provide functions of the function modules 101-105.

The establishment module 101 can establish a relationship between a lip feature and word information. In at least one embodiment, the establishment module 101 can establish the relationship between the lip feature and the word information by using lip reading technology. For example, when a Chinese word “fan” is spoken, the lip feature is “a lower lip opening slightly, a upper lip curved upward.” As mentioned above, the relationship can be stored into the lip feature storage unit 130 as a standard mapping table.

The recording module 102 can record a video of a user using the camera module 11 and the microphone 12, and store the video into the storage device 13. The video includes video data and voice data. In at least one embodiment, a user can record the video data using the camera module 11, and record the voice data using the microphone 12.

The determination module 103 can determine whether voice data of the video is the same as voice data of the user previously stored in the storage device 13. In at least one embodiment, the determination module 103 can extract timbre feature values of the voice data by using speech recognition technology. In at least one embodiment, the timbre feature values includes Linear Predictive Coding, Mel-Frequency Cepstral Coefficients, and Pitch. The determination module 103 determines whether the voice data of the video is the same as voice data of the user by determining whether the extracted timbre feature values is the same as a timbre feature value of the voice data of the user stored in the voice data storage unit 131.

In at least one embodiment, when the extracted timbre feature values is the same as the timbre feature value previously stored, it can be determined that the voice data of the video is the same as the voice data of the user already stored. When the extracted timbre feature values is different from the timbre feature value already stored, it can be determined that the voice data of the video is different from any voice data which is stored.

When the voice data of the video is the same as voice data already stored, the determination module 103 determines whether a decibel value of the voice data is less than a first predetermined value, for example, 60 dB. In at least one embodiment, the determination module 103 calculates the decibel value of the voice data being recorded, and compares the decibel value to the first predetermined value.

When the decibel value of the voice data is less than the first predetermined value, it can be determined that the voice data is too low, and not loud enough to be heard. When the decibel value of the voice data is equal to or greater than the first predetermined value, it can be determined that the voice data is sufficiently clear and loud enough.

The extracting module 104 can extract one or more video segments in which the decibel value is less than the first predetermined value. In at least one embodiment, the extracting module 104 can extract a voice data segment when the decibel value of the voice data is less than the first predetermined value, then extract the video segment corresponding to the extracted voice data segment.

When the voice data of the video is different from any voice data already stored, the extracting module 104 can extract the voice data of the user in the video.

The determination module 103 can determine whether the decibel value of the voice data of the user is greater than a decibel value of other voice data of the video. In at least one embodiment, when the decibel value of the voice data of the user is equal to or less than the decibel value of other voice data of the video, it can be determined that the voice data of the user is interfered by the other voice data in the video. In such case, it is difficult to understand what the user is said in the video. When the decibel value of the voice data of the user is greater than the decibel value of other voice data of the video, the voice data of the user may be not interfered by the other voice data in the video.

The determination module 103 further can determine whether a difference value between the decibel value of the voice data of the user and the decibel value of other voice data of the video is greater than a second predetermined value, for example 20 dB. When the difference value between the decibel value of the voice data of the user and the decibel value of other voice data of the video is greater than the second predetermined value, it can be determined that the voice data of the user is not being interfered by the other voice data of the video. In such case, it is sufficiently loud and clear to understand what the user is said in the video. When the difference value between the decibel value of the voice data of the user and the decibel value of other voice data of the video is equal to or less than the second predetermined value, it can be determined that the voice data of the user is interfered by the other voice data in the video.

The extracting module 104 can extract a video segment in which the difference value between the decibel value of the voice data of the user and the decibel value of other voice data of the video is equal to or less than the second predetermined value.

The processing module 105 can access word information corresponding to the voice data of the user in the extracted video segment according to the relationship. In at least one embodiment, the processing module 105 can extract images of the lip feature of the user from the video segment, and access word information from the voice data of the user based on the relationship. For example, when the extracted images of the lip feature of the user is “a lower lip opening slightly, a upper lip curved upward”, “fan” is generated as the word information.

The processing module 105 can output the word information, and further transform the word information to audible spoken words using the electronic device 1.

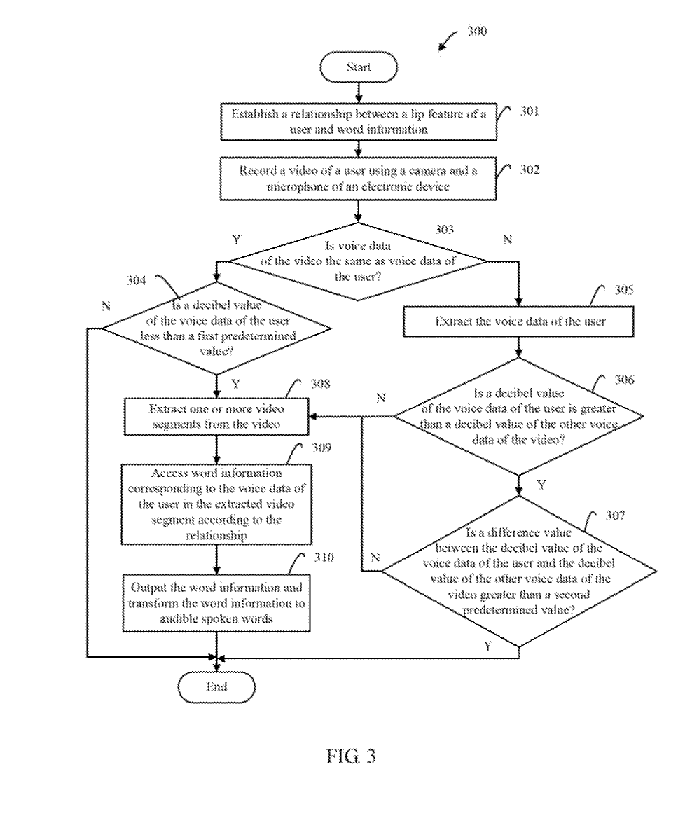

FIG. 3 illustrates a flowchart is presented in accordance with an example embodiment. An example method 300 is provided by way of example, as there are a variety of ways to carry out the method. The example method 300 described below can be carried out using the configurations illustrated in FIG. 1 and FIG. 2, and various elements of these figures are referenced in explaining the example method. Each block shown in FIG. 3 represents one or more processes, methods, or subroutines, carried out in the example method 300. Furthermore, the illustrated order of blocks is illustrative only and the order of the blocks can be changed according to the present disclosure. The example method 300 can begin at block 301. Depending on the embodiment, additional blocks can be utilized and the ordering of the blocks can be changed.

At block 301, an establishment module can establish a relationship between a lip feature and word information. In at least one embodiment, the establishment module can establish the relationship between the lip feature and the word information by using lip reading technology. For example, when a Chinese word “fan” is spoken, the lip feature is “a lower lip opening slightly, a upper lip curved upward.” As mentioned above, the relationship can be stored into the lip feature storage unit as a standard mapping table.

At block 302, a recording module records a video of a user using the camera and the microphone, and store the video into the storage device. The video includes video data and voice data. In at least one embodiment, a user can record the video data using the camera module, and record the voice data using the microphone.

At block 303, a determination module determines whether voice data of the video is the same as voice data of the user previously stored in the storage device. In at least one embodiment, the determination module can extract timbre feature values of the voice data by using speech recognition technology. In at least one embodiment, the timbre feature values includes Linear Predictive Coding, Mel-Frequency Cepstral Coefficients, and Pitch. The determination module determines whether the voice data of the video is the same as voice data of the user by determining whether the extracted timbre feature values is the same as a timbre feature value of the voice data of the user stored in the voice data storage unit.

In at least one embodiment, when the extracted timbre feature values is the same as the timbre feature value of the user, it can be determined that the voice data of the video is the same as the voice data of the user, the procedure goes to block 304. When the extracted timbre feature values is different from the timbre feature value of the user, it can be determined that the voice data of the video is different from the voice data of the user, the procedure goes to block 305.

When the voice data of the video is the same as the voice data of the user, at block 304, the determination module determines whether a decibel value of the voice data of the user is less than a first predetermined value, for example, 60 dB. In at least one embodiment, the determination module calculates the decibel values of the voice data of the video, and compares the decibel values to the first predetermined value. When the decibel value of the voice data of the user is less than the first predetermined value, the procedure goes to block 308. When the decibel value of the voice data of the user is equal to or greater than the first predetermined value, the procedure ends.

When the voice data of the video is different from any voice data already stored, at block 305, an extracting module can extract the voice data of the user in the video.

At block 306, the determination module determines whether the decibel value of the voice data of the user is greater than a decibel value of other voice data of the video. In at least one embodiment, when the decibel value of the voice data of the user is greater than the decibel value of other voice data of the video, the procedure goes to block 307. When the decibel value of the voice data of the user is equal to or less than the decibel value of other voice data of the video, the procedure goes to block 308.

When the decibel value of the voice data of the user is greater than the decibel value of other voice data of the video, at block 307, the determination module determines whether a difference value between the decibel value of the voice data of the user and the decibel value of the other voice data of the video is greater than a second predetermined value, for example, 20 dB. When the difference value between the decibel value of the voice data of the user and the decibel value of the other voice data of the video is greater than the second predetermined value, the procedure ends. When the difference value between the decibel value of the voice data of the user and the decibel value of the other voice data of the video is equal to or less than the second predetermined value, the procedure goes to block 308.

At block 308, the extracting module can extract one or more video segments from the video. In at least one embodiment, when the decibel value of the voice data of the user is less than the first predetermined value, the extracting module extracts one or more video segments in which the decibel value of the user is less than the predetermined value. When the difference value between the decibel value of the voice data of the user and the decibel value of the other voice data of the video is equal to or less than the second predetermined value, the extracting module extracts one or more video segments in which the difference value between the decibel value of the voice data of the user and the decibel value of the other voice data of the video is equal to or less than the second predetermined value, from the video.

At block 309, a processing module can access word information corresponding to the voice data of the user in the extracted video segment according to the relationship. In at least one embodiment, the processing module can extract images of the lip feature of the user from the video segment, and assess word information from the voice data of the user based on the relationship. For example, when the extracted images of the lip feature of the user is “a lower lip opening slightly, a upper lip curved upward,” “fan” is generated as the word information.

At block 310, the processing module can output the word information, and further transform the word information to audible spoken words using the electronic device.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a camera module;
a microphone;
at least one processor; and
a storage device that stores one or more programs which, when executed by the at least one processor, cause the at least one processor to:
establish a relationship between a lip feature and word information;
record a video of a user using the camera module and the microphone;
determine whether a decibel value of voice data of the user in the video is less than a first predetermined value;
extract one or more video segments in which the decibel value of the user is less than the first predetermined value;
access word information corresponding to the voice data of the user in the extracted video segment according to the relationship; and
output the word information.

2. The electronic device according to claim 1, wherein the at least one processor further:
determines whether the decibel value of the voice data of the user is greater than a decibel value of the other voice data of the video; and
extracts one or more video segments in which the decibel value of the voice data of the user is equal to or less than the decibel value of the other voice data of the video.

3. The electronic device according to claim 2, wherein the at least one processor further:
determines whether a difference value between the decibel value of the voice data of the user and the decibel value of the other voice data of the video is greater than a second predetermined value; and
extracts one or more video segments in which the difference value between the decibel value of the voice data of the user and the decibel value of the other voice data of the video is equal to or less than the second predetermined value.

4. The electronic device according to claim 1, wherein the at least one processor further:
transforms the word information to audible spoken words.

5. The electronic device according to claim 1, wherein the word information of the voice data of the user in the extracted video segment is accessed by:
extracting images of lip feature of the user from the video segment; and
accessing words based on the extracted images and the relationship.

6. A computer-implemented method for processing voice data using an electronic device being executed by at least one processor of the electronic device, the method comprising:
establishing a relationship between a lip feature and word information;
recording a video of a user using a camera module and a microphone of the electronic device;
determining whether a decibel value of voice data of the user in the video is less than a first predetermined value;
extracting one or more video segments in which the decibel value of the user is less than the first predetermined value;
accessing word information corresponding to the voice data of the user in the extracted video segment according to the relationship; and
outputting the word information.

7. The method according to claim 6, further comprising:
determining whether the decibel value of the voice data of the user is greater than a decibel value of the other voice data of the video; and
extracting one or more video segments in which the decibel value of the voice data of the user is equal to or less than the decibel value of the other voice data of the video.

8. The method according to claim 7, further comprising:
determining whether a difference value between the decibel value of the voice data of the user and the decibel value of the other voice data of the video is greater than a second predetermined value; and
extracting one or more video segments in which the difference value between the decibel value of the voice data of the user and the decibel value of the other voice data of the video is equal to or less than the second predetermined value.

9. The method according to claim 6, further comprising:
transforming the word information to audible spoken words.

10. The method according to claim 6, wherein the word information of the voice data of the user in the extracted video segment is accessed by:
extracting images of lip feature of the user from the video segment; and
accessing words based on the extracted images and the relationship.

11. A non-transitory storage medium having stored thereon instructions that, when executed by a processor of an electronic device, causes the processor to perform a method for processing voice data, the method comprising:
establishing a relationship between a lip feature and word information;
recording a video of a user using a camera module and a microphone of the electronic device;
determining whether a decibel value of voice data of the user in the video is less than a first predetermined value;
extracting one or more video segments in which the decibel value of the user is less than the first predetermined value;
accessing word information corresponding to the voice data of the user in the extracted video segment according to the relationship; and
outputting the word information.

12. The non-transitory storage medium according to claim 11, wherein the method further comprises:
determining whether the decibel value of the voice data of the user is greater than a decibel value of the other voice data of the video; and
extracting one or more video segments in which the decibel value of the voice data of the user is equal to or less than the decibel value of the other voice data of the video.

13. The non-transitory storage medium according to claim 12, wherein the method further comprises:
determining whether a difference value between the decibel value of the voice data of the user and the decibel value of the other voice data of the video is greater than a second predetermined value; and
extracting one or more video segments in which the difference value between the decibel value of the voice data of the user and the decibel value of the other voice data of the video is equal to or less than the second predetermined value.

14. The non-transitory storage medium according to claim 11, wherein the method further comprises:
transforming the word information to audible spoken words.

15. The non-transitory storage medium according to claim 11, wherein the word information of the voice data of the user in the extracted video segment is accessed by:
extracting images of lip feature of the user from the video segment; and
accessing words based on the extracted images and the relationship.
